(19) United States
(12) Patent Application Publication
(10) Pub. No.: US 2019/0104606 A1
(43) Pub. Date: Apr. 4, 2019

(54) SYSTEMS AND PROCESSES FOR PRODUCING RELATIVELY UNIFORM TRANSVERSE IRRADIATION FIELDS OF CHARGED-PARTICLE BEAMS

(71) Applicant: Rayton Solar Inc., Santa Monica, CA (US)

(72) Inventors: James Benjamin Rosenzweig, Los Angeles, CA (US); Mingguo Liu, Irvine, CA (US); Andrew X. Yakub, Stevenson Ranch, CA (US); Ninel Vartanian, Los Angeles, CA (US)

(21) Appl. No.: 16/150,267

(22) Filed: Oct. 2, 2018

Related U.S. Application Data
(60) Provisional application No. 62/567,108, filed on Oct. 2, 2017.

(51) Int. Cl. H05H 7/04

(52) U.S. Cl. CPC H05H 7/04; H05H 2007/043

(57) ABSTRACT

The hybrid beam emittance uniformization system includes a charged particle beam generator for emitting a plurality of charged particles, a quadrupole magnet positioned relatively inline with the charged particle beam generator, and an adjustable aperture quadrupole positioned inline with the charged particle beam generator, wherein the combination of the quadrupole magnet and the adjustable aperture quadrupole concentrate the plurality of charged particles emitted by the charged particle beam generator into a relatively uniform square beam having a relatively uniform flux density all throughout a target area positioned a target distance from the charge particle beam generator.

### BACKGROUND OF THE INVENTION

The present invention generally relates to systems and processes for generating charged-particle beams and more particularly the present invention is directed to systems and processes for producing relatively uniform transverse irradiation fields of charged-particle beams.

Particle accelerators are commonly used in fundamental scientific research, product design, development, and manufacturing. For example, focusing beams of charged particles on a target can be used to analyze the results of high-energy collisions of particles to probe the fundamental nature of matter at the subatomic level. This may occur by focusing two beams to collide with one another or by focusing a single beam for collision with a stationary target. In the latter example, the material properties of the stationary target may be further examined for changes in material properties for purposes of developing new materials and products. The charged particle beams can be controlled by different types and dispositions of magnets that create a magnetic field to control the path of the particle beam in a way commensurate with the aims of the researchers or manufacturing processes.

The magnetic fields generated by multiple magnet arrays nearby the magnets can be quite complicated, but at relatively long distances away from the magnets, the field can be described quite accurately by what is called in mathematics as a “multipole expansion”. For accelerator physics, this is typically a power series expansion of the magnetic field strength (or magnetic flux density) with the order of powers of the radial distance from the center of the field and some angle (for pipe-like particle beams, typically an azimuthal angle in cylindrical coordinates) away from the magnets increasing as (n−1) where n is the index of summation of the power series.

The individual terms of the power series are given names in accord with the number of poles of the magnet producing the field, and an odd or even order based on the order of the exponent of the terms in the power series. Since the field is created by magnets, there must be an even number of poles as the existence of a “monopole magnet” has not yet been definitively ascertained in Nature. Therefore, for example, a multipole expansion of the radial distance and azimuthal angle of the particle beam produced by an ideal 2n-pole magnet array, n=1 is called the dipole field and (in spite of the n value) is even-order in the power series, n=2 is called the quadrupole and is odd-order, n=3 is called the sextupole field and is even-order, n=4 is called the octupole field and is odd-order, n=5 is called the decapole field and is even-order, and n=6 the dodadecapole field and is odd-order, and so on.

More specifically, a dipole field 20 (e.g., having n=1, order=2) is illustrated in FIG. 1 being produced by a dipole magnet 22 having a pair of flat poles (i.e., a north pole 24 and an opposing south pole 26) that produce a relatively homogeneous magnetic field with the direction of the field following the right-hand rule, i.e., with counterclockwise circulating current (as shown in FIG. 1) in the magnet's coil producing a downward magnetic field, and vice versa. The dipole moment (i.e., the measure of the electrical polarity of a system of charges) can be measured according to the Lorentz force equation, namely F=qE+qv×B, where F is the force acting on the particle, q is the electric charge, E is the external electric field, v is the instantaneous particle velocity, and B is the magnetic field or magnetic flux density.

As illustrated in FIG. 2, a quadrupole field 28 (n=2, order=3) is created by disposing a pair of positive charges 30 and a pair of negative charges 32 in an alternating arrangement in generally orthogonal quadrants relative to one another, thereby forming a generally hyperbolic contour between respective charges 30, 32 to produce a substantially hyperbolic magnetic field. The quadrupole field 28 can be extended over a distance to form a standard quadrupole magnet 34 (FIG. 3) through use of a pair of generally elongated positive quadrupole rods 36 and a pair of generally elongated negative quadrupole rods 36 which horizontally focus and vertically defocus a charged particle 40, and vice-versa, depending on the magnet coil current direction in each of the rods 36, 38, the charge of the particle 40, and the direction of beam motion. As illustrated in FIG. 3, charged particles 40 emitted from a charged particle beam source 42 may generally be focused along a trajectory 44 by the quadrupole rods 36, 38 so the charged particles 40 generally target an area 46 at an exit 48 at some predefined distance away from the charged particle beam source 42. The horizontal force component of the magnetic field generated by the rods 36, 38 depends on the horizontal position of the charged particles 40, and similarly, the vertical force component depends on the vertical position of the charged particles 40, which may change along the trajectory 44. To this end, the quadrupole magnet 34 is designed to prevent the charged particles 40 from otherwise scattering after being emitted by the charged particle beam source 42 and before contacting the target area 46.

Accordingly, when the charged particles 40 deviate from the target area 46 along its trajectory 44, the magnetic quadrupole field 28 (FIG. 2) exerts a restoring force. In travel, multiple of the charged particles 40 emitted from the charged particle beam source 42 oscillate about a unique particle beam trajectory, a phenomenon called “betatron oscillation”. Because the quadrupole focal length depends on the momentum of the charged particles 40, there will be so-called “chromatic” errors. Conventionally, a sextuplet magnet (n=3, order=4), typically having six magnets with alternating poles facing each other in a hexagon configuration, could be used to help correct the chromatic errors by horizontal focusing and vertical defocusing, or vice-versa depending on accelerator machine configuration.

As illustrated in the schematic of FIG. 4, an octupole field 50 (n=4, order=5) can be produced by a set of eight magnets 52 arranged in an octagon pattern with alternating north and south poles facing a center 54 thereof through which the charged particle beam may pass. Similar to the quadrupole magnet 34, an octupole magnet 56 of similar construction may be formed by a series of alternating positively charged rods 58 and negatively charged rods 60, shown truncated in FIG. 5. The octupole magnets 52 and/or the charged rods 58, 60 may be used to reduce nonlinear coupling, and generally defocuses the charged-particles 40 and may thereby smooth the irradiation field at the target area 46.

The effective deployment of octupole magnets requires a quantitative analysis in determining the uniformity of the charged-particle beam transverse irradiation field. To begin, the octupole magnet may shape the charged particle beam in the transverse irradiation field of (x, y) according to:

4(x³y−xy²)=±r² Equation 1

Here, the x and y coordinates are orthogonal to the beam direction z, and r is the radial distance from the center of the octupole magnet field, so the y component of the magnetic field can be determined by:

B_{y}=α₄(x³−3xy²) Equation 2

Here, α₄ is a characteristic coefficient of the given octupole magnet, and B_{y} is a measure of the spreading of the beam sheet. To shape the transverse irradiation field of the particle beam to be more uniform as desired, the beam must be relatively small in the direction that one does not wish to apply the nonlinear focusing of the octupole magnets.

In this respect, the study of the area around the direction of travel of the charged particles 40 is called “transverse optics” because that area is transverse to the direction of propagation of the charged particles 40 and the magnets act like lenses controlling beam trajectory. The relatively flat target area 46 formed by the irradiation of the charged particles 40 in the beam can then be identified by two-dimensional Cartesian coordinates x and y.

Traditionally, magnet arrays used in research particle accelerators were typically designed to produce a narrow, focused beam concentrated on a small-area target (e.g., similar to a laser) and were generally described by a Gaussian distribution of beam intensity. Although, with advancements in technology, there are now various applications where it may be desirable for a particle beam to produce a more uniform transverse field. For example, particle beams have a more uniform transverse field may be beneficial for use in medicine such as to treat diseases (e.g., cancer), epidemiological afflictions, for the study of materials in materials science, and for the development of new products (e.g., varying in material properties at the subatomic level) during manufacturing.

The generation of a more uniform transverse irradiation field has been achieved to some extent by using “beam scanning” where a focused particle beam is deflected by a magnetic or electric field to scan the beam over a sample area resulting in a relatively more homogenous transverse distribution. The beam scanning technique produces greater particle beam transverse uniformity, but locally the particle flux is not continuous and is dependent on the scanning frequency, thus obviating some uniformity. The “beam scanning” process is insufficient for high accuracy applications, such as may be needed to exfoliate silicon wafer from an ingot workpiece during silicon wafer production having thicknesses less than 100 micrometers, and more specifically in the 2-70 microns or 4-20 micron range.

Another method to achieve a more uniform transverse particle beam irradiance distribution is to use a thin foil disposed perpendicular to the particle beam to scatter the particles so that the peak intensity spreads out. Although using this “beam expansion” technique produces a particle beam irradiance having a constant particle flux, it can be difficult to obtain high uniformity over a relatively large target area. Beam expansion by scattering of course attenuates the particle beam energy, which decreases the efficiency of the particle beam.

The transverse profile of a charged particle beam without nonlinear magnetic focusing and defocusing may produce a beam having an essentially Gaussian distribution of irradiation intensity. In this respect, FIG. 6 illustrates a Gaussian distribution 62 having a relatively narrow bell-shaped curve 64 charted against an x-axis distance 66 relative to a y-axis intensity 68. The bell-shaped curve 64 of the Gaussian distribution 62 attains a peak intensity 70 around a center 72 (where x=0) of the particle beam target and forms a pair of descending intensity tails 74, 76 respectively rapidly sloping away from the center 72 in respective minus-x (74) and plus-x (76) directions. “Smoothing” the Gaussian distribution 62 means decreasing the peak intensity 70 at or near the center 72 to a more plateau-like intensity distribution. A hypothetical ideal plateau intensity distribution 78 is illustrated with respect to FIG. 7. Here, the extent of the plateau 80 essentially forms the width of uniform transverse irradiance intensity.

The “emittance” of the charged particle beam is the phase space area (i.e., momentum versus generalized space coordinate) transverse to and surrounding the particle beam. In essence, the “emittance” is a measure of the average spread of particle coordinates in position-and-momentum phase space. As a particle beam propagates along the above-mentioned magnets and other beam-manipulating components of an accelerator, the position spread at the target may change; albeit in a way that does not change the emittance. Typically, distribution over phase space is represented as a cloud 82 in a plot 84, such as the conventional generally elliptically shaped cloud 82 illustrated in FIG. 8. Here, a relatively darker center 86 indicates areas of the cloud 82 having a higher concentration of charged particle contact and a relatively lighter periphery 88 indicate areas having relatively lower concentrations of charged particle contact. Thus, the darker center 86 is associated with higher concentrations near the beam center, with gradually declining into “fuzzy borders” about the periphery of the charged particle beam. The “emittance” is thus a measure of the laxness of the beam, and the “emittance growth” indicates a lack of transverse uniformity at the target. The “flux” is the number of particles crossing a given surface area per unit time, and “flux density” is the amount of flux per given cross-section. In some applications, the flux is ideally uniform over the entire target area, which is conventionally difficult to achieve due to the emittance growth of the beam over its trajectory, such as illustrated in FIG. 8.

Another device known in the art designed to smooth a Gaussian distribution into more of a transverse beamline is a Panofsky quadrupole magnet 90 as generally illustrated in truncated form in FIG. 9. The Panofsky quadrupole magnet 90 is a variation of the quadrupole magnet 34 disclosed above with respect to FIG. 3 from the standpoint that the positive quadrupole rods 36 and the negative quadrupole rods 38 are essentially replaced with a pair of positively charged plates 92 and a pair of negatively charges plates 94. As illustrated in FIGS. 9-10, the positively charged plates 92 are generally disposed in fixed relation and orthogonally positioned relative to the negatively charged plates 94, such that the charged plates 92, 94 alternate in polarity about each side of the generally rectangular or square cross-section, thereby forming a channel 96 to an interior of the Panofsky quadrupole magnet 90. In theory, the magnetic field formed by the relationship of the alternating polarity charged plates 92, 94 better guide the charged particles therein, at least with respect to the fact that the charged plates 92, 94 cooperate to form the channel 96 that restricts stray movement of uncharged or unstable trajectory charged particles. Similar to the quadrupole magnet 34, each of the charged plates 92, 94 may generally extend along a length of the Panofsky quadrupole magnet 90 in similar construction as each of the quadrupole rods 36, 38 of the quadrupole magnet 34.

In operation, the Panofsky quadrupole magnet 90 includes a magnetic vector potential A defined by the following:

$$A = \frac{{α}_{2}}{2} z ( {y}^{2} - {x}^{2} ) \qquad Equation 3$$

Here, α₂ is a characteristic coefficient describing the given Panofsky quadrupole magnet, and x, y, and z are Cartesian coordinates as illustrated in FIG. 9. As for all quadrupole magnets, the horizontal component of the magnetic field depends only on the horizontal position of the particle in the beam and the vertical magnetic field depends only on the vertical position of the particle. For example, if the charged particle 40 is heading into one of the positively charged plates 92, then the charged particle 40 moving in the z-direction at a point (x, y)=(0, y) will deflect toward the center (0, 0) by a magnetic force proportional to y, thereby forming a converging lens in the y-projection. In the x-projection, the Panofsky quadrupole magnet 90 acts as a diverging lens. If there are two Panofsky quadrupole magnets of equal strength along the z-axis, there are weak x+y focusing, thereby promoting the desired uniform sheet beam.

In some prior art embodiments, the Panofsky quadrupole magnet 90 is known to include a relatively wide channel 96, such that the cross-section takes on a rectangular shape as illustrated best in FIG. 10. Here, FIG. 10 illustrates a schematic head-on view of a wide-aperture, rectangular Panofsky quadrupole magnet 90′ having a relatively long horizontal x-axis side 98 and relatively shorter vertical y-axis side 100. Here, the magnetic field distribution can be calculated by:

2xy=±r² Equation 4

In Equation 4, r is the radial distance from the center of the Panofsky quadrupole magnet 90′ and x, y represent Cartesian coordinate distances the charged particle is from the center of the Panofsky quadrupole magnet 90′.

Moreover, an odd-order multipole approach to the problem associated with beam streamline was discussed in Y. Yuri, N. Miyawaki, T. Kamiya, W. Yokota, K. Arakawa, M. Fukuda, Uniformization Of The Transverse Beam Profiles By Means Of Nonlinear Focusing Method, Physical Review Special Topics-Accelerators and Beams 10 (10) (2007) 104001 (hereinafter “Yuri”), the contents of which are herein incorporated by reference in its entirety. Yuri studied the transverse irradiation field uniformization for odd-order multipole magnetic fields using a relatively high 100 MeV kinetic energy particle beam with concomitantly large momentum resulting in a total beam path length of approximately 40 m.

The theoretical and numerical calculations using a 100 MeV charged-particle beam disclosed by Yuri show that the utilization of nonlinear multipole magnets can achieve a higher particle beam irradiation uniformity at a constant particle flux over an entire surface area of a relatively large output target, and potentially better than both the beam scanning and beam expansion methods.

Starting from the equations of motion for the particles in a charged particle beam, a focusing and defocusing linear magnet (e.g., a quadrupole magnet) and a smoothing nonlinear multipole magnet (e.g., an octupole magnet) are conceptually disposed on a path s to the target, where the nonlinear multipole magnet generates a nonlinear magnetic field for beam profile transformation.

For determining the character of the transverse irradiation field at the target area, the particle beam irradiation field can be expanded in a power series for the horizontal x and vertical y coordinates of the beam, where z is the direction of propagation of the beam. Considering only a quadrupole and octupole, the coupled, nonlinear transverse differential equations of motion at the target can be expressed by:

$$\begin{matrix}{x}^{″} + {K}_{4} ( s ) x + {\sum }_{n = 3}^{∞} \frac{{K}_{2 n}}{( n - 1 ) !} Re [ {( x + iy )}^{n - 1} ] = 0 & Equation 5 \\ {y}^{″} - {K}_{4} ( s ) y + {\sum }_{n = 3}^{∞} \frac{{K}_{2 n}}{( n - 1 ) !} Re [ {i ( x + iy )}^{n - 1} ] = 0 & Equation 6\end{matrix}$$

Here, the double primes indicate second derivatives with respect to s, and K₄ and K₂ₙ are the linear quadrupole and 2n-pole non-linear multipole magnetic field strengths, respectively. These equations cannot be solved analytically, but can be expanded:

$$\begin{matrix}{x}^{″} + {K}_{4} ( s ) x + \frac{{K}_{6}}{2} {x}^{2} [ 1 - {( \frac{y}{x} )}^{2} ] + \frac{{K}_{8}}{3 !} {x}^{3} [ 1 - 3 {( \frac{y}{x} )}^{2} ] + … = 0 & Equation 7 \\ {y}^{″} - {K}_{4} ( s ) x - {K}_{6} xy + \frac{{K}_{8}}{3 !} {y}^{3} [ 1 - 3 {( \frac{x}{y} )}^{2} ] + … = 0 & Equation 8\end{matrix}$$

Yuri indicates that Equations 7 and 8 can be the working equations of the horizontal and vertical motion of the particles in the beam and can be used to determine the transverse beam profile.

Yuri further shows that an odd-order nonlinear field, such as an octupole field, theoretically may fold the tails of the transverse Gaussian irradiance field in phase space (momentum versus generalized space coordinate), creating a sharper-walled plateau for the irradiance distribution. Odd-order fields, such as the octupole, fold both tails of the Gaussian simultaneously because the magnetic force depends on the sign of the betatron oscillation amplitude.

The comprehensive study set forth in Yuri, however, is purely theoretical and, although numerical calculations show the uniformization effects of multipole magnetic fields on the particle beam irradiation distribution, the implementation and actualization of the theory requires the determination of significant mechanical factors and parameters, for example, for constructing machines that can effectively carry out the desired particle beam transverse uniformization, the layout and design of the magnets themselves, and the specific parameters of the magnets and the particle beam must be determined before a practical machine to produce a uniform transverse irradiation field can be realized.

In fact, Yuri cautions that high-order magnets creating such uniformization would be difficult to fabricate, and the attainment of sufficient aperture size and high magnetic field gradient necessary for large-area transverse field uniformity would be difficult. Moreover, the theoretical study disclosed in Yuri using a 100 MeV kinetic energy beam, which momentum then requires a beam path length of at least 40 m long, is clearly impractical for many medical, materials science, and manufacturing uses.

There exists, therefore, a significant need in the art for an efficient system and process for transforming a Gaussian transverse charged particle beam distribution into a relatively square distribution with uniform density to facilitate, e.g., uniform exfoliation of rectangular semiconductor targets (e.g., for applications in solar manufacturing and similar uses of low energy ion beams) through deployment of specially shaped magnetic optics to obtain an approximately uniform distribution. The present invention fulfills these needs and provides further related advantages.

### SUMMARY OF THE INVENTION

In one embodiment as disclosed herein, an adjustable aperture quadrupole may include a first charge plate having a first charge and a second charge plate having a second charge and positioned generally opposite the first charge plate and offset therefrom by an adjustable distance. In this respect, the first charge may be the same as the second charge, i.e., both charges may be positive (+) or negative (−). A charged particle transfer chamber may be positioned between the opposing first and second charge plates and have a size and shape for facilitating transfer of charged particles through the adjustable aperture quadrupole within a magnetic field formed through interaction of the first charge of the first charge plate and the second charge of the second charge plate. Accordingly, the characteristics of the magnetic field are responsive to the adjustable distance between the first charge plate and the second charge plate. In this respect, an adjuster coupled to at least one of the first charge plate or the second charge plate may selectively set the adjustable distance between the first charge plate and the second charge plate to define the magnetic field within the charged particle transfer chamber through which charged particles travel. Of course, the adjuster could be coupled to both of the first charge plate and the second charge plate for adjustment of both simultaneously.

In one embodiment, the adjustable aperture quadrupole may include a support frame generally having a box-like structure with a rectangular cross-section. Here, the adjuster may generally suspend the first charge plate, the second charge plate, and the charged particle transfer chamber therebetween relative to the support frame about a pivot formed at a terminating end of an outwardly extending support. In one embodiment, the outwardly extending support may include a set of triangular-shaped brackets that downwardly extend from an upper vertical support of the support frame. Here, the adjuster may pivot relative to the support frame about an axis. Moreover, the adjuster may include a piston configured to be positionable between a retracted position, wherein the adjustable distance is relatively smaller, and an extended position, wherein the adjustable distance is relatively larger. At least one linkage having a support bar may extend from the piston and terminate in an eyelet pivotally coupled to a yoke-based pivot rod to facilitate relative movement of the first (upper) charge plate relative to the second (lower) charge plate.

Additionally, the charged particle transfer chamber may include a deflectable vacuum sealed housing responsive to movement of the adjuster. Here, the deflectable vacuum sealed housing may simultaneously couple to each of the first and second charge plates, whereby defection of the deflectable vacuum sealed housing causes commensurate relative movement of each of the first and second charge plates, effectively changing the adjustable distance therebetween. To this end, the deflectable vacuum sealed housing may include an adjustable height and an adjustable width.

The first and second charge plates may further include at least a pair of coils having a rib extending at least partially into an offset therebetween spatially offsetting the respective pair of coils; a respective first and second yokes positioned stationary relative to the respective pair of coils; and a respective first and second pole faces generally outwardly extending from distal sides of the respective coil pairs. Each of the first and second pole faces may include an inwardly presented inner fillet proximate the respective coil pairs for creating positive higher order modes, or each of the first and second pole faces may include an outwardly presented fillet distal the respective coil pairs for creating negative higher order modes. Additionally, each of the first and second pole faces may have a geometric shape for generating an octupole moment in the absence of a current source.

In another aspect of these embodiments, the charged particle transfer chamber may include a pair of zero charge sides formed generally orthogonal relative to each of the first and second charge plates, which is different than a conventional Panofsky quadrupole that requires four charge plates of alternating charge positioned relatively statically orthogonal relative to one. Of course, in this respect, the zero charge sides may effectively selectively move relative to the first and second charge plates, such as by way of the deflectable vacuum sealed housing.

In another embodiment, the charged particle transfer chamber may have a width and a height relatively larger than a height and a width of a charged particle beam. A first-order focusing field may include wherein the height is approximately 5 cm and the width is approximately 30 cm, to form a relatively rectangular-shaped uniform beam having a Cartesian width of approximately 15 cm when a charged particle beam passes therethrough. Alternatively, the transverse width of the charged particle transfer chamber may be approximately 2σ of a Gaussian beam size. In another aspect of this embodiment, the charged particle transfer chamber may have a wall thickness of approximately 3 mm. Additionally, the adjustable charged particle transfer chamber may include a vacuum chamber to help reduce particle loss.

In another embodiment, a hybrid beam emittance uniformization system as disclosed herein may include a charged particle beam generator for emitting a plurality of charged particles, a quadrupole magnet positioned relatively inline with the charged particle beam generator, and an adjustable aperture quadrupole positioned inline with the charged particle beam generator. Here, the combination of the quadrupole magnet and the adjustable aperture quadrupole concentrate the plurality of charged particles emitted by the charged particle beam generator into a relatively uniform square beam having a relatively uniform flux density at a target area positioned at a target distance from the charge particle beam generator.

In another aspect of this embodiment, the hybrid system may include a second quadrupole magnet positioned inline with the charged particle beam generator and a second adjustable aperture quadrupole inline with the charged particle beam generator and positioned downstream from the second quadrupole magnet. Here, the second quadrupole magnet may be generally offset from the adjustable aperture quadrupole by approximately 45 degrees and generally axially aligned with the first quadrupole magnet. Additionally, the second adjustable aperture quadrupole may be generally offset from the second quadrupole magnet and turned approximately 45 degrees into a general vertical orientation offset by approximately 90 degrees from the first adjustable aperture quadrupole. The relatively uniform square beam may include a relatively uniform transverse distribution.

In another aspect of these embodiments, the adjustable aperture quadrupole may include a rectangular-shaped vacuum chamber. Moreover, each of the quadrupole magnet and the adjustable aperture quadrupole may focus one dimension of the plurality of charged particles at a time. Here, the quadrupole magnet may include a first order focusing moment and the adjustable aperture quadrupole may include a second higher order folding moment, wherein the adjustable aperture quadrupole is positioned downstream of the charged particle beam generator and the quadrupole magnet and generally offset therefrom by approximately 45 degrees. Lastly, the relatively uniform square beam may include a y-axis distribution of approximately 0.2 meters and an x-axis distribution of approximately 0.2 meters, and the quadrupole magnet may include a maximum field gradient of 0.79 T/m.

In another embodiment, a process for producing a relatively uniform transverse irradiation field of a charged-particle beam includes emitting a charged particle beam with a beam generator, sizing the charged particle beam with a quadrupole magnet for passage through an adjustable aperture quadrupole, and transforming the charged particle beam with the adjustable aperture quadrupole into a transverse charged particle beam having a relatively square distribution and a relatively uniform density.

Additionally, the process may include adding an octupole moment with the adjustable aperture quadrupole, desensitizing a peak intensity of the charged particle beam with a second adjustable aperture quadrupole, shaping a magnetic scalar potential equipotential with a pair of pole faces integrated into the adjustable aperture quadrupole, exciting a higher order field with the pair of pole faces, changing the higher order field while generally maintaining a quadrupole strength, including performing the changing step in real-time, passing the charged particle beam through the adjustable aperture quadrupole with relatively lossless transmission, folding a Gaussian transverse beam distribution with a positive octupole moment, fine tuning a transverse beamline of the charged particle beam, and changing an excitation current and scaling the field amplitude. Moreover, the octupole moment may include a positive octupole moment or a negative octupole moment and the quadrupole magnet may include a first order focusing moment and the adjustable aperture quadrupole may impart a high order folding moment to attain the transverse charged particle beam.

In another embodiment, a process for adjusting a field component strength of a quadrupole may include disposing a first charge plate having a first charge relative to a second charge plate having a second charge generally positioned opposite thereof and adjusting an offset distance between the first charge plate and the second charge plate, thereby simultaneously altering a magnetic field in an adjustable channel having a size and shape for controlled passage of a charged particle beam therethrough. Additionally, this process may include the step of independently controlling a field component strength by shifting at least one of a first pole face associated with the first charge plate or a second pole face associated with the second charge plate, wherein shifting displaces the first and second pole faces relative to one another about a symmetry plane. Moreover, an electrical current may be generated through at least one coil in each of the first and second charge plates to generate the respective first and second charges. Here, the at least one coil may include an upper coil residing within an upper charge plate and a lower coil residing within a lower charge plate.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic view of a dipole field formed by a dipole magnet;

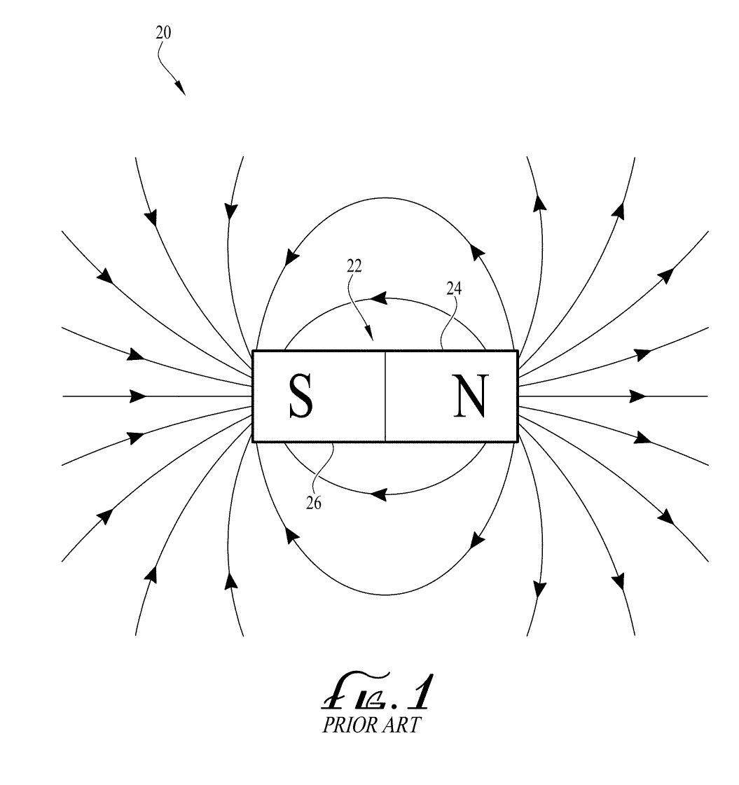

FIG. 2 is a schematic view of a quadrupole field;

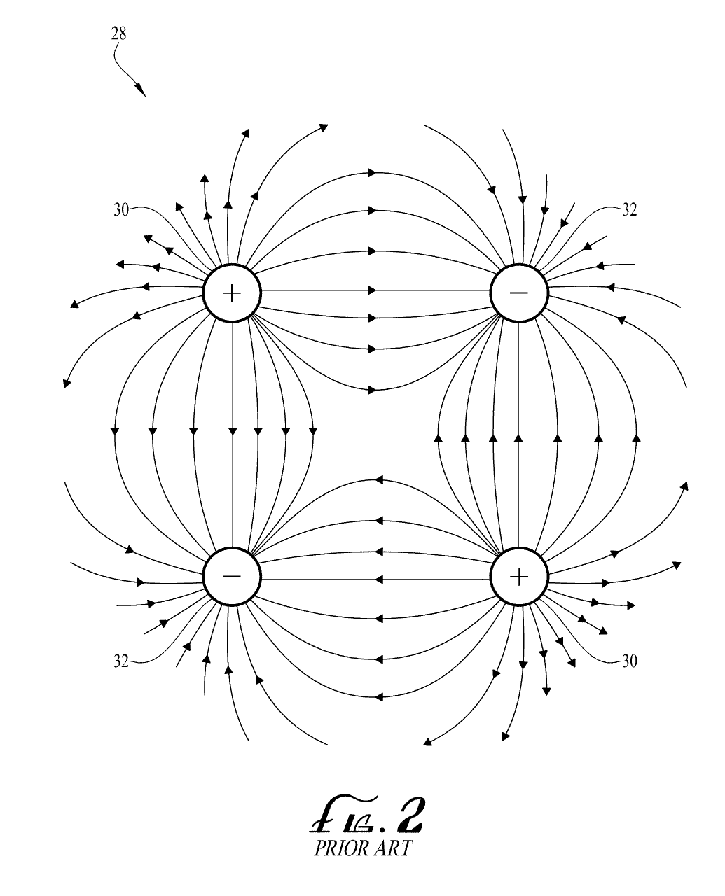

FIG. 3 is a perspective schematic view of a quadrupole magnet having a pair of positive quadrupole rods and a pair of negative quadrupole rods for focusing charged particles from a charged particle beam source to a target area along a length thereof;

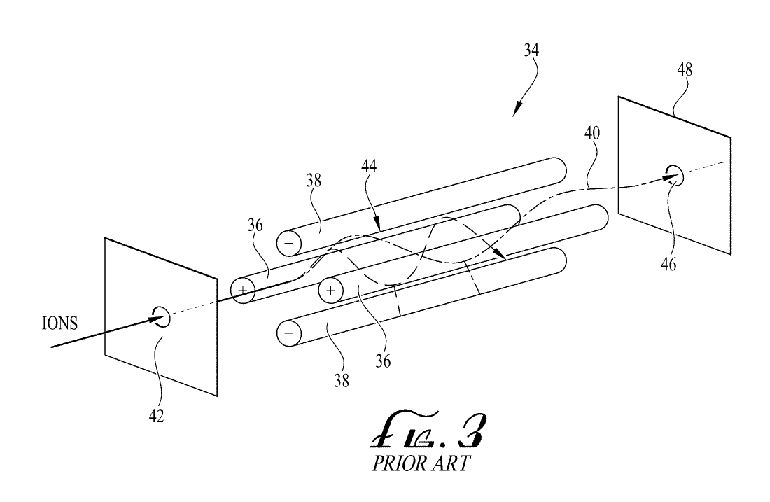

FIG. 4 a schematic view of a octupole magnet having end facing alternating magnetic poles arranged in an octagonal relationship;

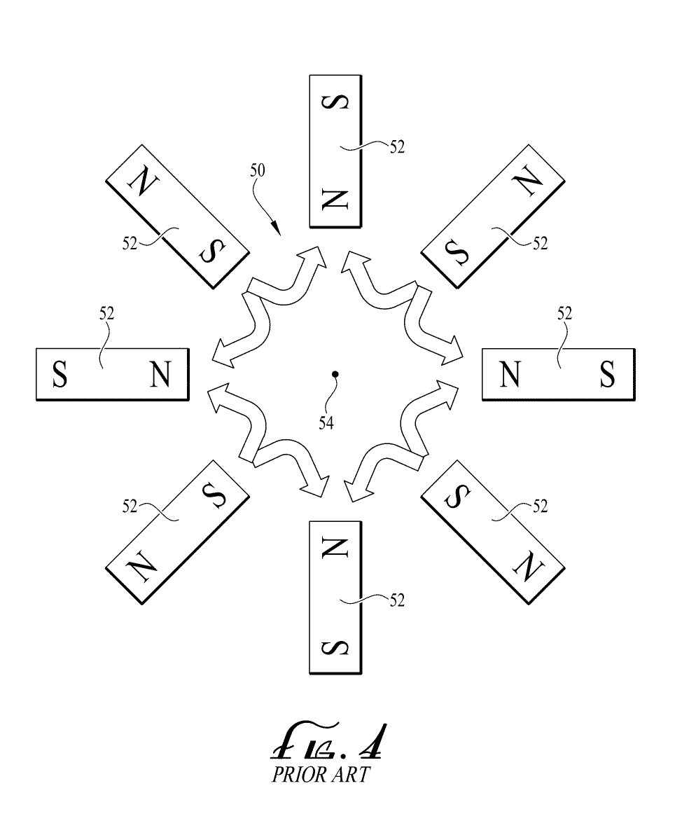

FIG. 5 is a perspective view of the octupole magnet illustrated with respect to FIG. 4;

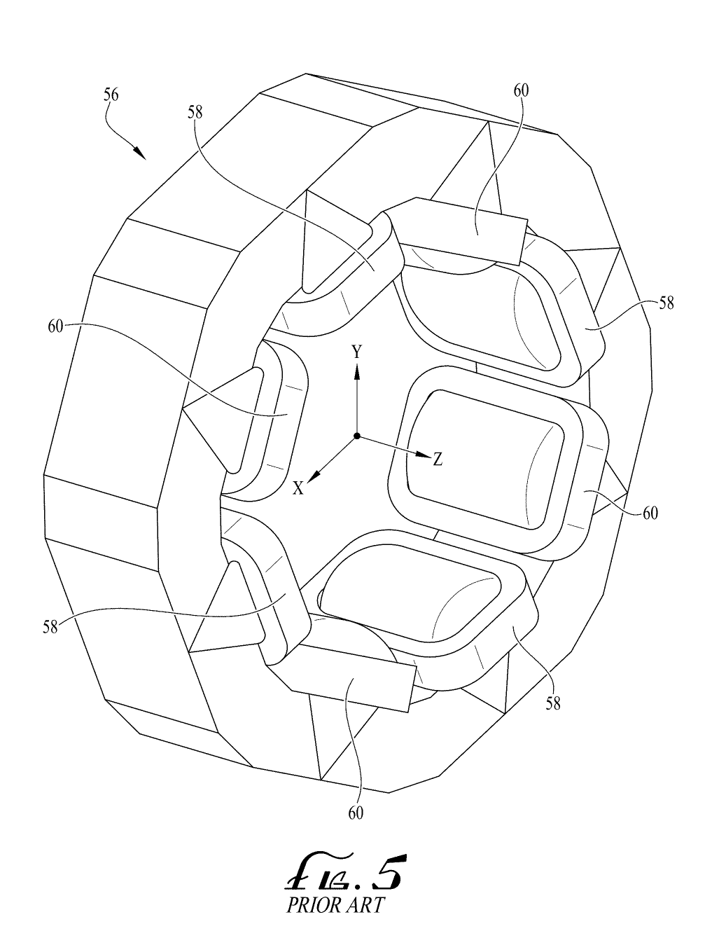

FIG. 6 is a diagrammatic view of an idealized Gaussian intensity distribution;

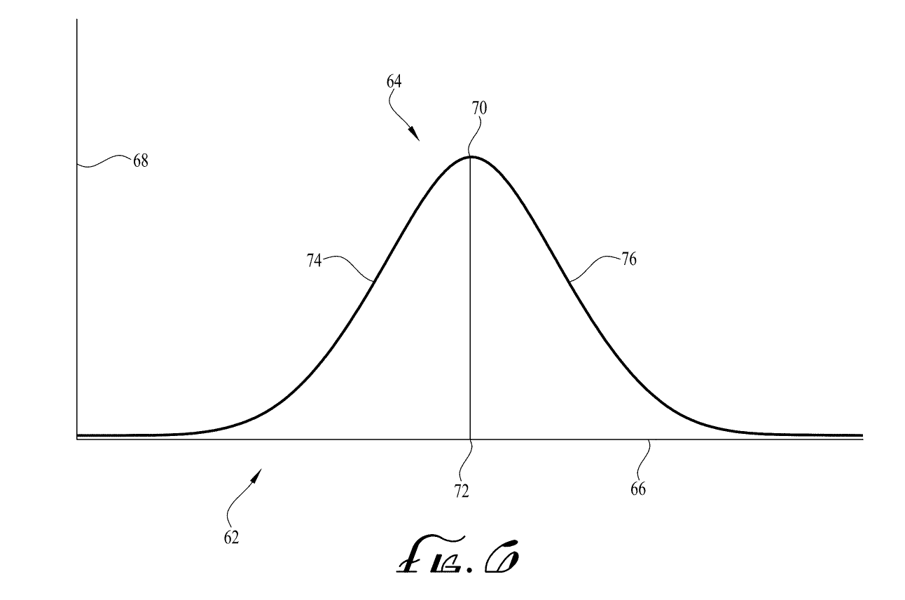

FIG. 7 is a diagrammatic view of an idealized plateau intensity distribution;

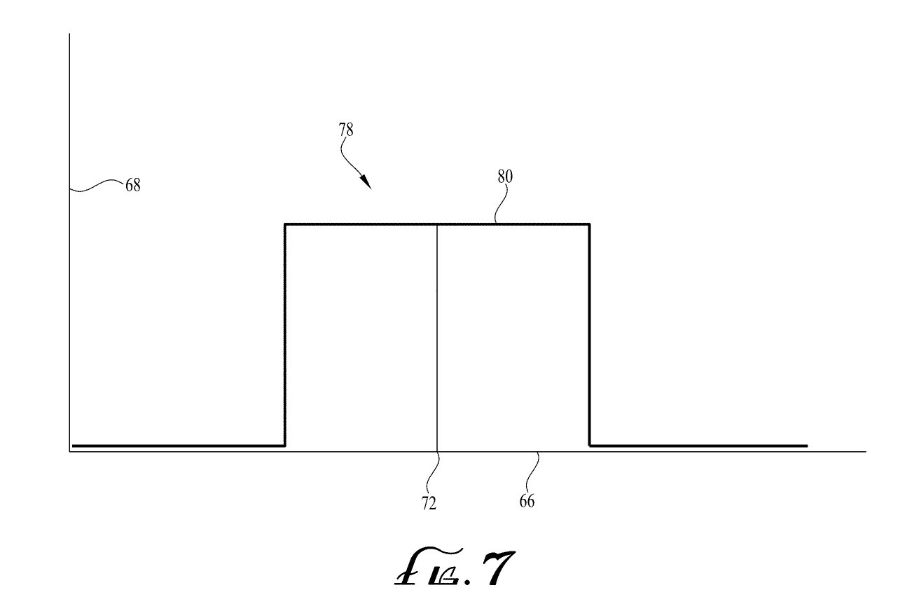

FIG. 8 is a scatter plot illustrating a relative distribution of charged particle emittance in a general elliptical shape, with relatively heavier concentrations at a darker center and relatively lower concentrations along a relatively lighter periphery;

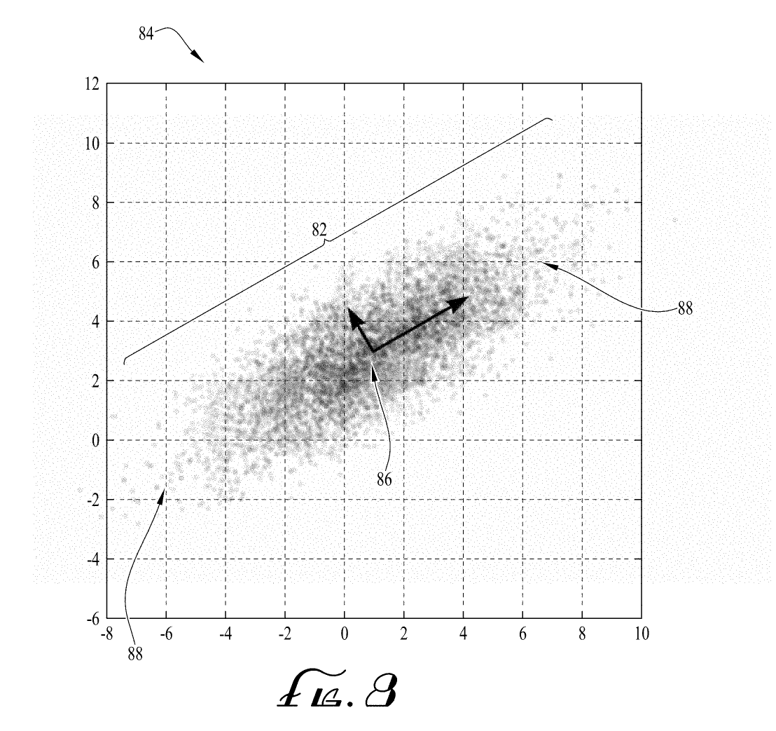

FIG. 9 is a perspective view of one embodiment of a Panofsky quadrupole magnet;

FIG. 10 is an end view of an alternatively-shaped rectangular-faced Panofsky quadrupole magnet, further illustrating current directions and a relatively wide channel;

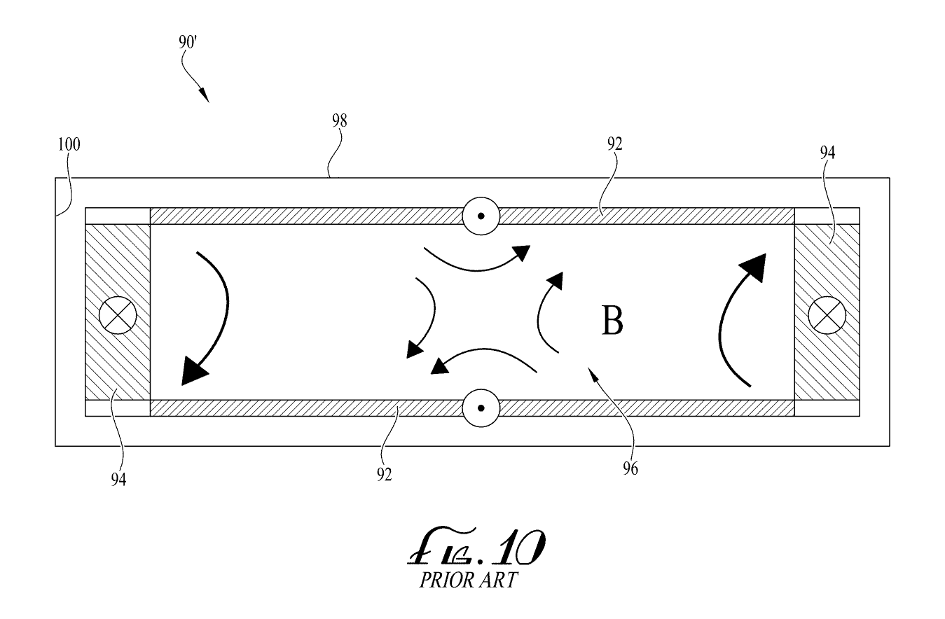

FIG. 11 is a perspective view of one embodiment of a hybrid beam emittance uniformization system as disclosed herein, for producing a relatively more uniform beamline through deployment of a normal quadrupole and a adjustable aperture quadrupole;

FIG. 12 is a perspective view of the adjustable aperture quadrupole;

FIG. 13 is a cross-sectional view of the adjustable aperture quadrupole taken about the line 13-13 of FIG. 12;

FIG. 14 is a schematic illustrating an end view of the adjustable aperture quadrupole, including only an upper charge plate and a lower charge plate;

FIG. 15 is a perspective view of a pair of pole faces having inner fillets for creating positive higher order modes;

FIG. 16 is a perspective view of a pair of pole faces having outer fillets for creating negative higher order modes;

FIG. 17 is a plot illustrating an on-axis field magnitude in a positive displacement region as a function of a high order pole face vertical offset; and

FIG. 18 is a plot illustrating a transverse distribution density at the end of the uniformization beamline on top of a proposed target shape according to one embodiment of the hybrid beam emittance uniformization system disclosed herein.

### DETAILED DESCRIPTION OF THE PREFERRED EMBODIMENTS

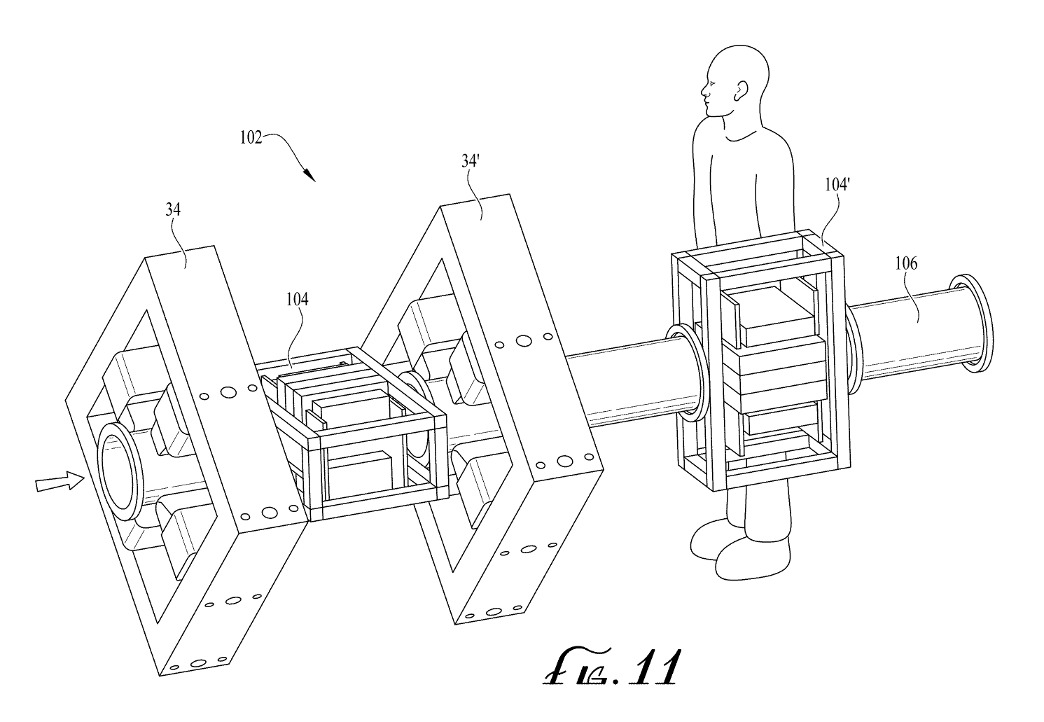

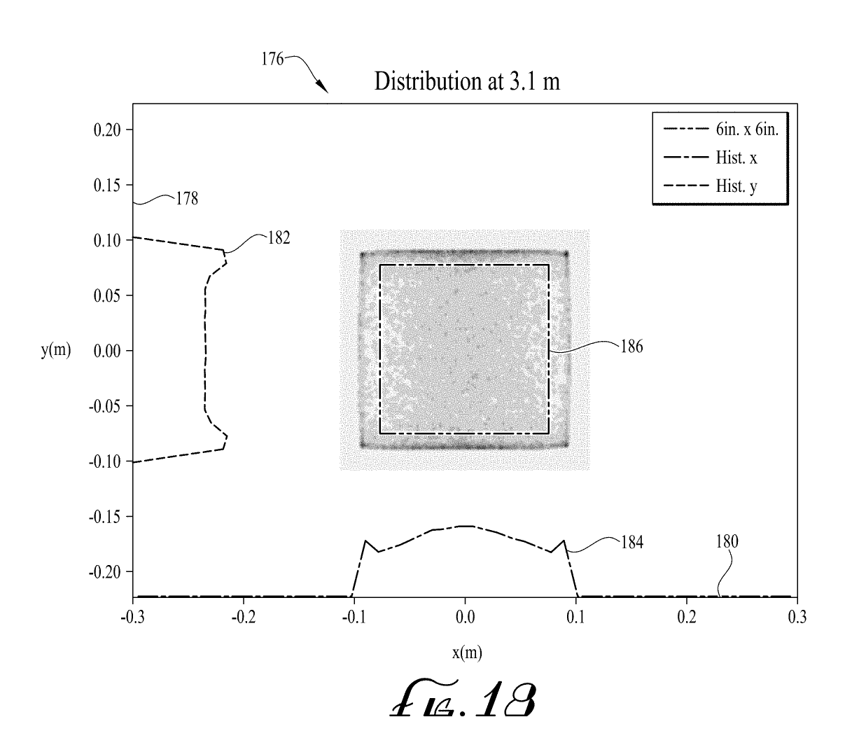

As shown in the exemplary drawings for purposes of illustration, the present invention for a hybrid beam emittance uniformization system for producing relatively uniform transverse irradiation fields of charged-particle beams is generally illustrated in FIG. 11 with respect to reference numeral 102, which includes an adjustable aperture quadrupole 104, as disclosed herein and illustrated in more detail with respect to FIGS. 11-13, and expands on the concepts disclosed in U.S. Appl. No. 62/567,108, the contents of which are herein incorporated by reference in its entirety. As illustrated in FIG. 11, the hybrid beam emittance uniformization system 102 as disclosed herein is able to create a relatively uniform transverse distribution through use of an adjustable aperture quadrupole 104 in combination with a standard quadrupole magnet 34. In the embodiment illustrated in FIG. 11, a first standard quadrupole magnet 34 is positioned in line along a beam tube 106 in a first orientation generally offset by approximately 45 degrees relative to a following first vertically oriented adjustable aperture quadrupole 104. Moreover, in the embodiment illustrated in FIG. 11, the beam tube 106 travels through the first adjustable aperture quadrupole 104 and into a second quadrupole magnet 34′ generally offset from the first adjustable aperture quadrupole 104 by approximately 45 degrees such that the first and second quadrupole magnets 34, 34′ are generally axially aligned. The beam tube 106 then continues from the second quadrupole magnet 34′ into a second adjustable aperture quadrupole 104′ generally offset from the second quadrupole magnet 34′ and turned by approximately 45 degrees into a general vertical orientation offset by approximately 90 degrees from the first adjustable aperture quadrupole 104. To this end, charged particles that pass through the waistline of each of the progressively positioned first quadrupole magnet 34, first adjustable aperture quadrupole 104, second quadrupole magnet 34′, and second adjustable aperture quadrupole 104′, exit the hybrid beam emittance uniformization system 102 having a desired uniform transverse distribution, such as illustrated with respect to FIG. 18, as discussed in more detail below.

Moreover, the hybrid beam emittance uniformization system 102 mentioned above provides enhanced uniform transverse beam densities by transforming the Gaussian transverse spatial distribution emanating from a standard accelerator source using higher order fields to more efficiently “fold over” the wings of the Gaussian distribution towards the center of the beam. While the “fold over” concept has been demonstrated with separate quadrupole and octupole magnets, as briefly discussed above, the hybrid beam emittance uniformization system 102 disclosed herein further utilizes a modified version of the Panofsky-style magnets in the form of the adjustable aperture quadrupole 104 to achieve an unexpectedly more consistent beam distribution in the target area. Thus, the hybrid beam emittance uniformization system 102 is able to achieve higher order fields by altering the outer pole faces of the nominally quadrupole geometry as illustrated, e.g., with respect to FIG. 11, to create a more uniform density beam. Essentially, the hybrid beam emittance uniformization system 102 has a first order focusing moment as well as a higher order “folding” moment. In this respect, a generally elongated channel is well suited for beams with large aspect ratios and also provides the flexibility to straightforwardly add the octupole component, due to freedom of design in the extreme ends of the magnet in the dimension where the beam is large.

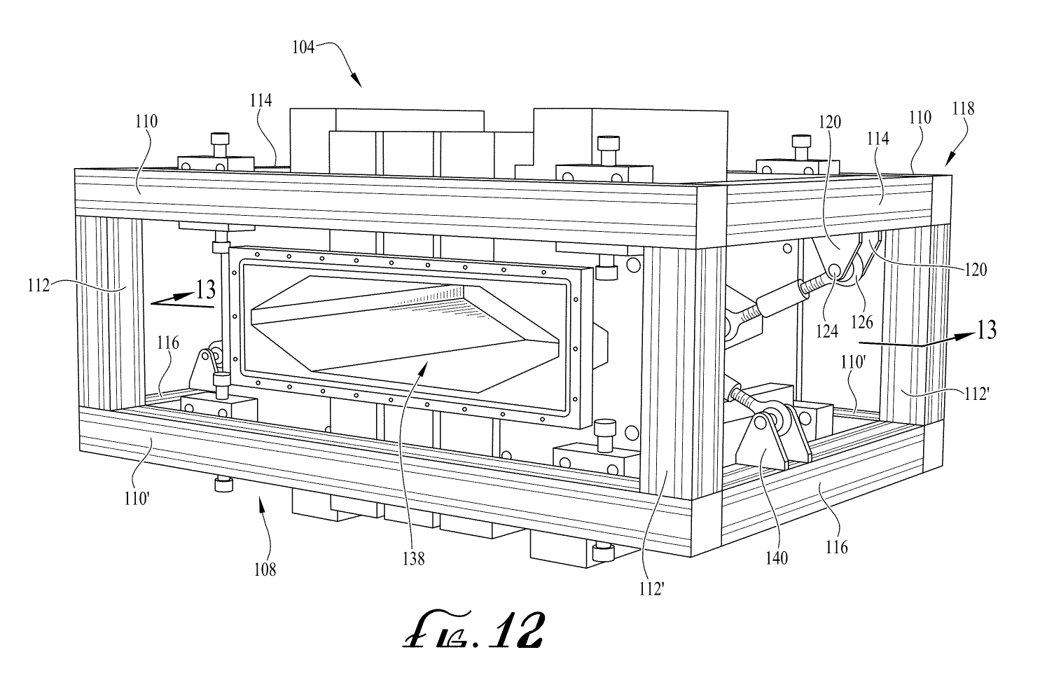

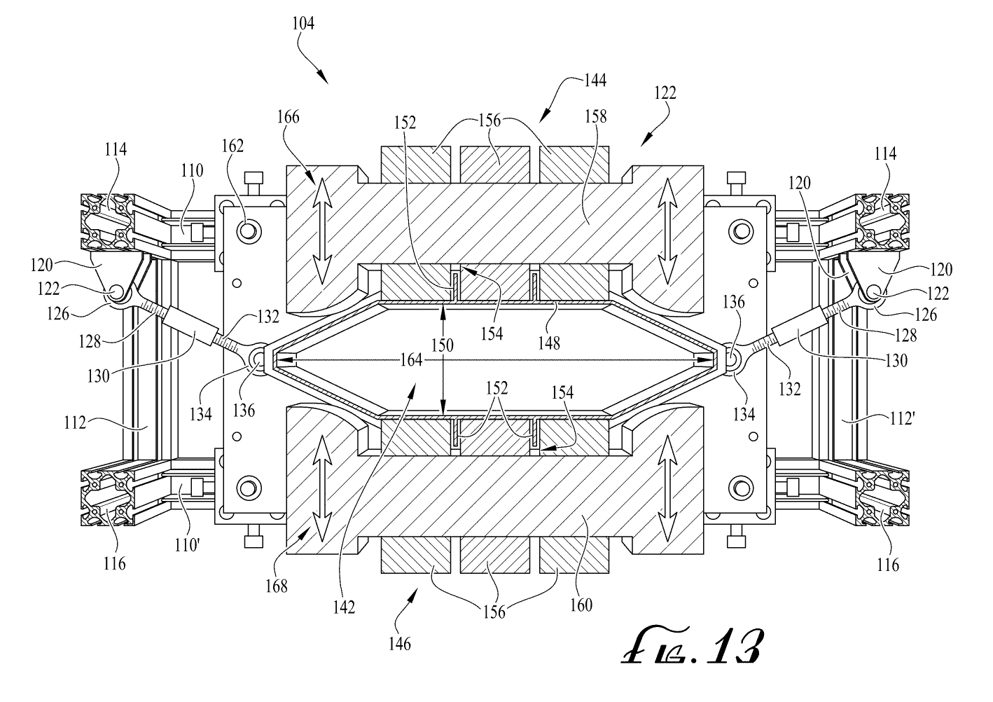

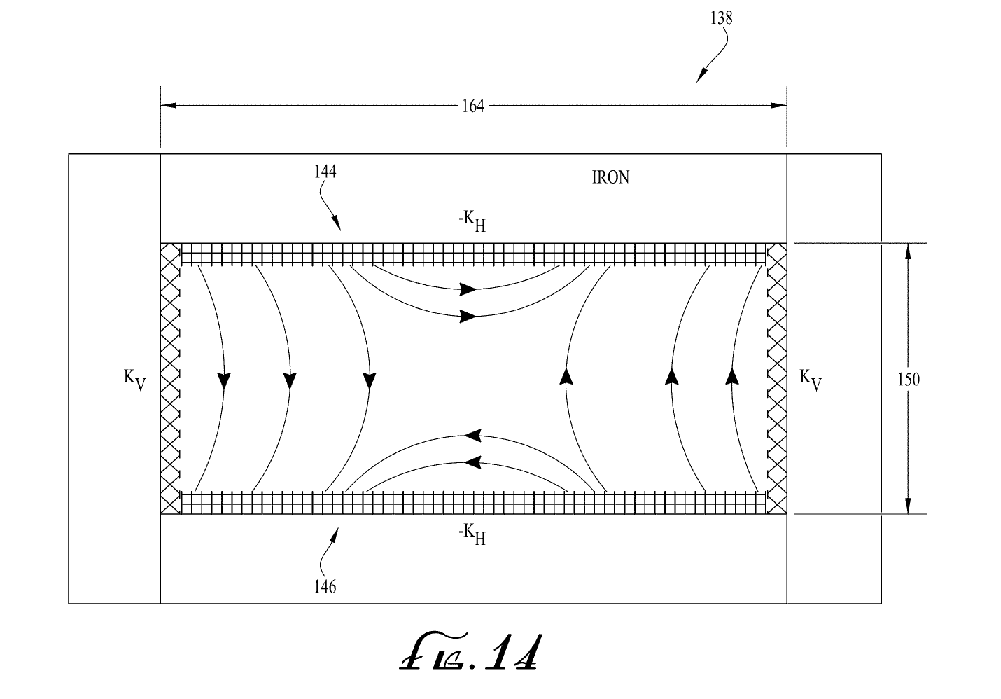

The adjustable aperture quadrupole 104 is more specifically illustrated in FIG. 12 and the cross-sectional view of FIG. 13 and includes box-like structure having an outer supportive frame 108 that includes, from a front plan view, a pair of generally elongated upper and lower horizontal supports 110, 110′ that intersect a pair of relatively shorter left and right vertical supports 112, 112′. Each of the horizontal supports 110, 110′ and the vertical supports 112, 112′ frame a generally rectangular cross-section as best illustrated in FIGS. 13 and 14 configured for pass through of a charged particle beam as disclosed herein. The outer supportive frame 108 further includes a pair of rearward upper horizontal supports 114 and a pair of rearward lower horizontal supports 116 that essentially couple to a reciprocal pair of the horizontal supports 110, 110′ and a pair of the vertical supports 112, 112′ forming a similar rectangular cross-section toward a rear side 118 of the adjustable aperture quadrupole 104.

As illustrated more specifically in the cross-sectional view of FIG. 13, each of the rearward upper horizontal supports 114 of the adjustable aperture quadrupole 104 includes a pair of triangular-shaped supports 120 downwardly extending from about a mid-point thereof. Each of the downwardly extending triangular supports 120 include a circular aperture 122 to generally support and suspend a support rod 124 (FIG. 12) therebetween. The distance between each of the downwardly extending triangular supports 120 accommodates an eyelet 126 extending from one end of a linkage 128 that couples to a piston 130 at an opposite end thereof. The piston 130 then couples to an interiorly located secondary linkage 132 having a similar eyelet 134 that couples to a yoke-based pivot rod 136. In this respect, the triangular supports 120 cooperate with the linkage 128, the piston 130, and the secondary linkage 132 to generally suspend a vacuum chamber 138 from the outer supportive frame 108.

In an alternative embodiment, the adjustable aperture quadrupole 104 may include a reciprocal set of upwardly extending triangular supports 140 (FIG. 12) coupled to each of the rearward lower horizontal supports 116 to provide additional support for the vacuum chamber 138 relative to the outer supportive frame 108. To this end, the upwardly extending triangular supports 140 may include a comparable aperture 122, support rod 124, eyelet 126, linkage 128, piston 130, and secondary linkage 132 for select pivoted coupling with a similar yoke-based pivot rod 136 of the vacuum chamber 138, in accordance with the embodiments disclosed above with respect to the downwardly extending triangular supports 120. The downwardly extending triangular supports 120 and the upwardly extending triangular supports 140 may cooperate to provide enhanced support and suspension of the vacuum chamber 138 from the outer supportive frame 108, in accordance with the embodiments disclosed herein.

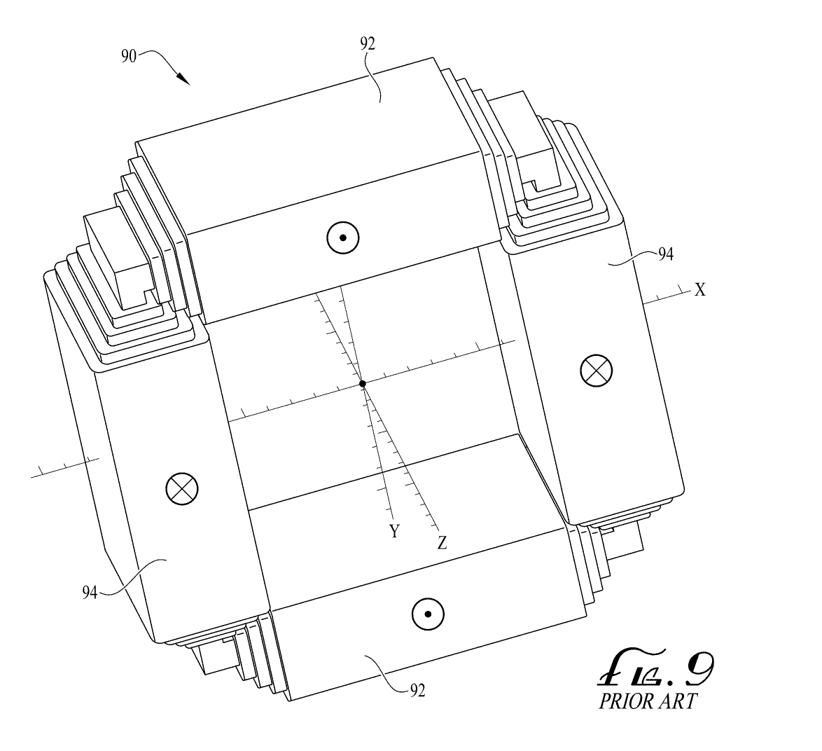

As discussed above, conventional Panofsky quadrupoles, such as the one illustrated with respect to FIG. 9, include a series of alternating charged plates (e.g., the positive charge plates 92 and the negative charge plates 94) in a relatively fixed position relative to one another. As such, this effectively fixes the size of the aperture or channel 96 formed thereby.

One aspect of the adjustable aperture quadrupole 104 as disclosed herein is that it includes an adjustable aperture or channel 142 that may change in size (e.g., height, width, and/or shape) depending on the desired application. More specifically, as best illustrated in FIG. 13, the adjustable aperture quadrupole 104 generally includes an upper charge plate 144 and a lower charge plate 146 vertically movable relative to one another through extension and/or attraction of each of the pistons 130, i.e., the the pistons 130 effectively act is a vacuum chamber adjustment. More specifically in this respect, extension of each of the pistons 130 toward an interior of the adjustable aperture quadrupole 104 generally causes pivoting movement of the eyelets 134 about each of the rods 136. In turn, a vacuum chamber housing 148 deflects the upper charge plate 144 upwardly simultaneously while deflecting the lower charge plate 146 downwardly, thereby increasing a vertical gap 150 therebetween. As illustrated in FIG. 13, the vacuum chamber housing 148 includes outwardly extending vacuum chamber ribs 152 that extend at least partially into a relatively small offset 154 separating a plurality of coils 156 that generate electrical current therein to effectively magnetize the upper charge plate 144 and the lower charge plate 146. In this respect, an upper main yoke 158 and a lower main yoke 160 remain respectfully stationary relative to each of the coils 156 and the vacuum chamber housing 148 along with the outwardly extending vacuum chamber ribs 152 at least partially residing within the offsets 154 between each of the coils 156 (e.g., racetrack coils able to provide field excitation). Conversely, to decrease the vertical gap 150, each of the pistons 130 may retract the respective secondary linkages 132, thereby causing each of the eyelets 134 to again pivot about the respective pivot rods 136. Here, the vacuum chamber housing 148 deflects inwardly, thereby closing the vertical gap 150 between each of the upper charge plate 144 and the lower charge plate 146. The adjustable aperture quadrupole 104 may also include a fine traverse magnet adjustment knob 162, as illustrated in FIG. 13.

To this end, one difference between the adjustable aperture quadrupole 104 as disclosed herein and that of a conventional Panofsky quadrupole is the fact that the adjustable aperture quadrupole 104 includes only two charge plates for operation, i.e., the upper charge plate 144 and the lower charge plate 146. The adjustable aperture quadrupole 104 does not include or require the use of side charge plates, such as the negatively charged plates 94 illustrated in FIG. 9 with respect to the Panofsky quadrupole magnet 90. As such, because the upper charge plate 144 and the lower charge plate 146 are not fixed relative to one another (e.g., by the negatively charged plates 94), this allows relative offset positioning of the upper charge plate 144 relative to the lower charge plate 146 to vary the vertical gap 150 therebetween, as needed and/or desired, including in real-time. This may be particularly useful to fine tune the transverse beamline for specific (sensitive) applications such as silicon ingot exfoliation.

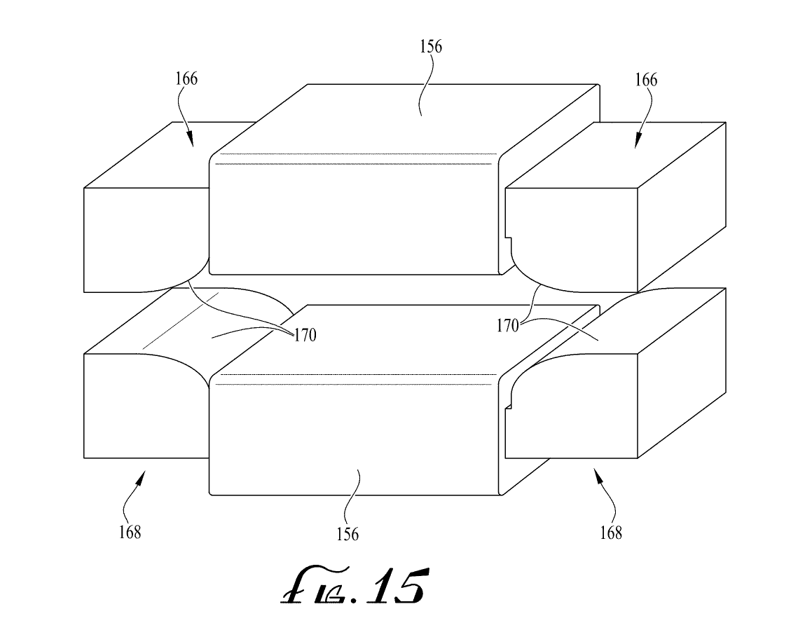

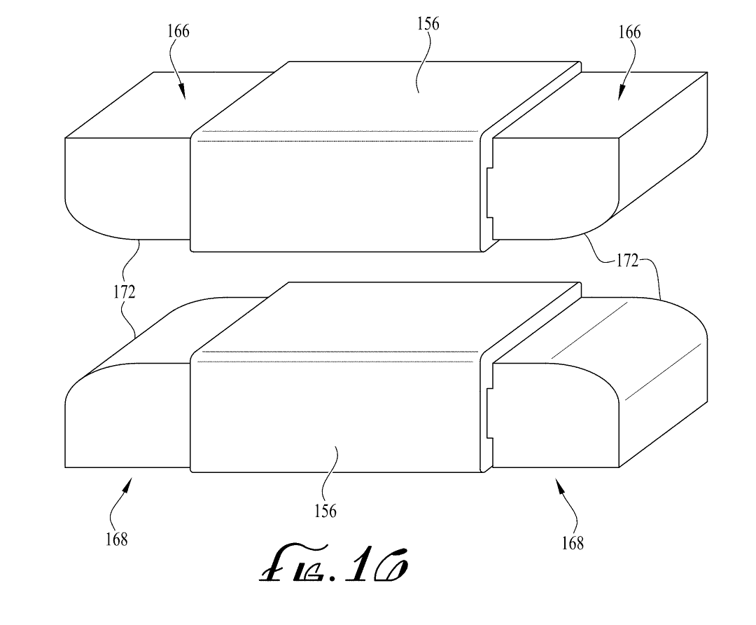

Additionally, the adjustable aperture quadrupole 104 may include a respective upper pole face 166 and a lower pole face 168 that vary in geometric shape to attain a desired higher order mode. Here, e.g., the pole faces 166, 168 generally outwardly extend from each of the coils 156 (e.g., generally illustrated as a single block in FIGS. 15 and 16). More specifically, in the embodiment illustrated in FIG. 15, the poles faces 166, 168 include a generally block-shaped geometric shape with an inner fillet 170 inwardly presented and adjacent each of the coils 156. In this embodiment, the pole faces 166, 168 having the inner fillet 170 create positive higher order modes. Alternatively, FIG. 16 illustrates an alternative embodiment wherein each of the upper pole face 166 and the lower pole face 168 include a respective set of outer fillets 172 upwardly presented yet distal the coils 156. In this embodiment, each of the pole faces 166, 168 create negative higher order modes. Of course, other configurations as may be known in the art may be used in connection with each of the upper pole face 166 and the lower pole face 168.

In one embodiment, the adjustable aperture quadrupole 104 may start with a simple first-order focusing field having the vertical gap 150 of approximately 5 cm and a horizontal gap 164 (FIG. 13) of approximately 30 cm. This setting produces a relatively square-shaped uniform beam having a Cartesian width of approximately 15 cm when a charged particle beam is passed therethrough to a target (e.g., an exfoliation surface of a silicon workpiece). In this embodiment, the rectangular aperture supported by the upper main yoke 158 and the lower main yoke 160 may include, in one embodiment, wherein the vacuum chamber housing 148 includes a wall thickness of approximately 3 mm.

Generally, in one embodiment during operation, the vertical gap 150 and the horizontal gap 164 may be greater than the width of the charged particle beam to sustain the quadrupole field throughout the adjustable channel 142. Although, to create a strong enough higher-order field component, the transverse width may be reduced to about 2σ of the Gaussian beam size. Outside of this limit, the pole faces 166, 168 may be shaped to create an octupole moment, and unlike a standard Panofsky quadrupole geometry, no current sources may be present. The pole faces 166, 168 may shape the magnetic scalar potential equipotentials such that higher order modes are excited. The nominal mirror symmetry of the hybrid beam emittance uniformization system 102 may assure that any even order multi poles are nonexistent.

The choice to create a positive octupole moment (i.e., a rising field) or a negative octupole moment (i.e., a falling field) with the shaped pole faces 166, 168 may depend on several considerations. First, the shape of the adjustable channel 142 must allow the charged particle beam to pass through without significant losses. A positive higher order octupole requires that the pole faces 166, 168 reduce the effective size of the adjustable channel 142 so that the vacuum chamber housing 148 terminates a distance far enough away from a mid-plane of the charged particle beam path. A negative multipole does not have this limitation, as the effective bore size increases as a function of offset.

A second consideration that has an impact on beamline design is where the effective octupole focus is located. A positive octupole moment leads to folding that creates a uniform distribution when the beam is converging, which means the uniform distribution will be before the waist created by the quadrupole component (e.g., quadrupole magnets 34, 34′ in FIG. 11), as the hybrid beam emittance uniformization system 102 is generally focusing the dimension of the octupole action. The converse of having a negative higher order multipole is also true, i.e., the uniform distribution point is after the corresponding waist. For purposes of silicon ingot exfoliation, such as those processes disclosed in U.S. Pat. Nos. 9,499,921 and 9,404,198, the contents of which are herein incorporated by reference in their entireties, the beam should go through the waist at least once for the desired folding to happen to attain the desired transverse dimensions illustrated, e.g., as illustrated in FIG. 18.

Another consideration applies to tuning the strengths of the different multipole orders. The adjustable aperture quadrupole 104 may include two ways to systematically change the structure of the fields. Changing the excitation current may scale the field amplitude. If the high order pole tips generated by the coils 156 are movable relative to the inner pole, e.g., such as by way of changing the vertical gap 150 with the pistons 130, they can change the higher order fields while minimally changing the quadrupole strength. This adds a beamline design consideration as it may be advantageous to create a charged particle beam transport having nominally strong quadrupole gradients such that there is a wide tuning range for the higher order moments as there is more physical room for adjustment.

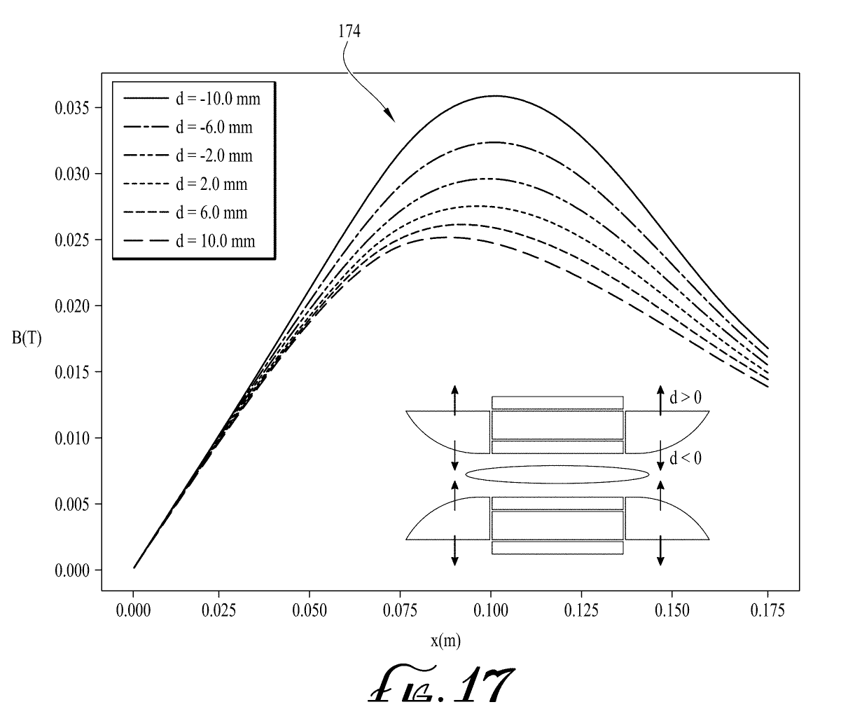

FIG. 17 illustrates a series of field maps 174 modeled using a 3D static magnetic field solver in Ansoft Electronics Desktop Suite (“Ansoft Software”) with respect to the adjustable aperture quadrupole 104 having the outer fillets 172 for creating negative higher order modes. In this embodiment, the upper main yokes 158, 160 were modeled as low carbon 1010 steel to take into account any saturation issues. Meshing was automatically refined by the Ansoft Software to account for edges and the curvature of the pole faces 166, 168 which were designed based on equipotential solutions to the 2D Laplacian in polar coordinates:

Ψₙ(ρ,θ)=ρⁿsin(nθ) Equation 8

Ψₙ(ρ,θ)=−ρ⁻ⁿsin(nθ) Equation 9

Here, Equation 8 represents a positive n-th order and Equation 9 represents a negative n-th order.

A pole profile was created using the equipotential lines for an n=3 moment with a radius on the scale of the beam size. The pole shape was then translated to meet conveniently with the edge of the Panofsky region. A translation of this type creates a spectrum of higher order odd n terms, which does not have notable negative consequences towards the folding goal of the magnet.

The strength of the field can be altered by changing the current density in the excitation coils 156. A standard conservative maximum current density recommended for air-cooled coils is 1.5 A/mm² and that the field is linear with current density even when exceeding this limit. Any possible saturation effects, localized or otherwise, may not be an issue in the nominal operating regime.

The higher order field component strength can be controlled independently of the overall scale factor by shifting the outer pole faces 166, 168 toward or away from the symmetry plane of the magnet. The field profile results due to this shifting are illustrated in the field maps 174 in FIG. 17.

Referring back to FIG. 11, each of the pair of adjustable aperture quadrupoles 104, 104′ and the quadrupole magnets 34, 34′ were used in a simulated beamline to create a square of uniform density for illustrative purposes. Here, the first quadrupole magnet 34 is used to defocus the beam vertically such that the beam is sized properly for the adjustable aperture quadrupole 104 at the location of the focal point in the horizontal direction. The adjustable aperture quadrupole 104 is placed at this location and provides a weak, negative octupole kick with an effective focal length to match the location of ideal transverse beam size after the initial waist of the quadrupole magnet 34. The second quadrupole magnet 34′ ensures that the vertical beam waist is located at the correct location of the horizontally acting adjustable aperture quadrupole 104, as determined by the focal length of the first quadrupole 34. The octupole kick of the second adjustable aperture quadrupole 104′ may be positive and much stronger than the first as the focal length is much shorter. A chart 176 illustrating a y-axis distribution 178 and an x-axis distribution 180 of the charged particles is illustrated in FIG. 18.

In this simulation, the respective y-axis field strength 182 and the x-axis field strength 184 are not perfectly optimized as optimization with field maps is difficult and tedious. Regardless, the strengths 182, 184 are systematic enough and within range of an ideal field strength 186. Thus, the simulated strengths of magnets needed for this beamline are attainable using conventional techniques. The quadrupole magnets 34, 34′ require a maximum field gradient of 0.79 T/m; and the adjustable aperture quadrupoles 104, 104′ require a current density about 30 percent lower than the limit imposed by using air cooled coils, thus giving an ample safety margin.

Current models of the quadrupole magnets 34, 34′ and the adjustable aperture quadrupoles 104, 104′ can roughly predict the weight of the beamline elements. The current design of the adjustable aperture quadrupoles 104, 104′ suggests a weight around 400-600 lbs, not including mounting hardware. The 10 in. bore quadrupoles have yet to be fully optimized for size but they are expected to weigh around 1,000-1,500 lbs, not including mounting hardware.

Inclusion of the vacuum chamber 142 is designed to reduce particle loss, which may be important for overall efficiency and minimizing heating effects due to particle collisions. Losses in the first adjustable aperture quadrupole 104 are generally nonexistent because the beam remains Gaussian during transport through the quadrupole 104 due to peak particle densities in the center. Once the charged particle beam reaches the second adjustable aperture quadrupole 104′, its peak desensitizes on the edges of the distribution. In this case, the vacuum chamber 138 is enlarged as much as possible to accommodate the new distribution. This prevents the vacuum chamber 138 from having a simple rectangular shape without significantly reducing the strength of the higher order moments as one must reduce the size of the adjustable channel 142 as a function of the axis offset. The resulting transverse shape of one embodiment of the vacuum chamber 138 is illustrated in FIG. 14.

In general, the hybrid beam emittance uniformization system 102 incorporating a combined set of standard quadrupole-octupoles and the adjustable aperture quadrupoles 104, 104′ provides consistency with needed functionality of the nonlinear beam optics for transforming a Gaussian profile beam to a uniform square at, e.g., a target area.

Although several embodiments have been described in detail for purposes of illustration, various modifications may be made without departing from the scope and spirit of the invention. Accordingly, the invention is not to be limited, except as by the appended claims.

What is claimed is:

1. An adjustable aperture quadrupole, comprising:
a first charge plate having a first charge;
a second charge plate having a second charge and positioned generally opposite the first charge plate and offset therefrom by an adjustable distance;
a charged particle transfer chamber positioned between the opposing first and second charge plates and having a size and shape for facilitating transfer of charged particles through the adjustable aperture quadrupole within a magnetic field formed through interaction of the first charge of the first charge plate and the second charge of the second charge plate, the characteristics of the magnetic field being responsive to the adjustable distance between the first charge plate and the second charge plate; and
an adjuster coupled to at least one of the first charge plate or the second charge plate for selectively setting the adjustable distance between the first charge plate and the second charge plate to define the magnetic field within the charged particle transfer chamber through which charged particles travel.

2. The adjustable aperture quadrupole of claim 1, including a support frame comprising a generally box-like structure having a rectangular cross-section, the adjuster generally suspending the first charge plate, the second charge plate, and the charged particle transfer chamber relative to the support frame.

3. The adjustable aperture quadrupole of claim 2, wherein the adjuster couples to the support frame about a pivot formed at a terminating end of an outwardly extending support.

4. The adjustable aperture quadrupole of claim 3, wherein the outwardly extending support comprises a pair of triangular-shaped brackets downwardly extending from a vertical support of the support frame.

5. The adjustable aperture quadrupole of claim 2, wherein the adjuster pivots relative to the support frame.

6. The adjustable aperture quadrupole of claim 1, wherein the adjuster includes a piston positionable between a retracted position and an extended position, wherein the adjustable distance is relatively smaller when the piston is in the retracted position relative to when the piston is in the extended position.

7. The adjustable aperture quadrupole of claim 6, including at least one linkage including a support bar extending from the piston and terminating in an eyelet pivotally coupled to a yoke-based pivot rod.

8. The adjustable aperture quadrupole of claim 1, wherein the charged particle transfer chamber includes a deflectable vacuum sealed housing responsive to movement of the adjuster.

9. The adjustable aperture quadrupole of claim 8, wherein the deflectable vacuum sealed housing simultaneously couples to each of the first and second charge plates, whereby defection thereof causes relative movement of each of the first and second charge plates.

10. The adjustable aperture quadrupole of claim 8, wherein the deflectable vacuum sealed housing includes an adjustable height and an adjustable width.

11. The adjustable aperture quadrupole of claim 1, wherein the first and second charge plates include at least a pair of coils having a rib extending at least partially into an offset spatially offsetting the respective pair of coils.

12. The adjustable aperture quadrupole of claim 11, wherein the first and second charge plates include respective first and second yokes positioned stationary relative to the respective pair of coils.

13. The adjustable aperture quadrupole of claim 11, wherein the first and second charge plates include respective first and second pole faces generally outwardly extending from each side of the respective pair of coils.

14. The adjustable aperture quadrupole of claim 13, wherein each of the first and second pole faces include an inwardly presented inner fillet proximate the respective pair of coils for creating positive higher order modes.

15. The adjustable aperture quadrupole of claim 13, wherein each of the first and second pole faces include an outwardly presented fillet distal the respective pair of coils for creating negative higher order modes.

16. The adjustable aperture quadrupole of claim 13, wherein each of the first and second pole faces comprise a shape generating an octupole moment in the absence of a current source.

17. The adjustable aperture quadrupole of claim 1, wherein the charged particle transfer chamber includes a pair of zero charge sides formed generally orthogonal relative to each of the first and second charge plates.

18. The adjustable aperture quadrupole of claim 17, wherein the zero charge sides selectively move relative to the first and second charge plates.

19. The adjustable aperture quadrupole of claim 1, wherein the charged particle transfer chamber includes a width and a height relatively larger than a height and a width of a charged particle beam.

20. The adjustable aperture quadrupole of claim 19, wherein a first-order focusing field includes wherein the height comprises approximately 5 cm and the width comprises approximately 30 cm, thereby forming a relatively rectangular-shaped uniform beam having a Cartesian width of approximately 15 cm when a charged particle beam passes therethrough.

21. The adjustable aperture quadrupole of claim 1, wherein the charged particle transfer chamber comprises a wall thickness of approximately 3 mm.

22. The adjustable aperture quadrupole of claim 1, wherein a transverse width of the charged particle transfer chamber comprises approximately 2σ of a Gaussian beam size.

23. The adjustable aperture quadrupole of claim 1, wherein the adjustable charged particle transfer chamber comprises a vacuum chamber for reducing particle loss.

24. The adjustable aperture quadrupole of claim 1, wherein the first charge comprises the same charge as the second charge.

25. A hybrid beam emittance uniformization system, comprising:
a charged particle beam generator for emitting a plurality of charged particles;
a quadrupole magnet positioned relatively inline with the charged particle beam generator; and
an adjustable aperture quadrupole positioned inline with the charged particle beam generator, the combination of the quadrupole magnet and the adjustable aperture quadrupole concentrating the plurality of charged particles emitted by the charged particle beam generator into a relatively uniform square beam having a relatively uniform flux density at a target area positioned a target distance from the charge particle beam generator.

26. The system of claim 25, including a second quadrupole magnet positioned inline with the charged particle beam generator and a second adjustable aperture quadrupole inline with the charged particle beam generator and positioned downstream from the second quadrupole magnet.

27. The system of claim 26, wherein the second quadrupole magnet is generally offset from the adjustable aperture quadrupole by approximately 45 degrees and generally axially aligned with the first quadrupole magnet.

28. The system of claim 26, wherein the second adjustable aperture quadrupole is generally offset from the second quadrupole magnet and turned approximately 45 degrees into a general vertical orientation offset by approximately 90 degrees from the adjustable aperture quadrupole.

29. The system of claim 25, wherein the relatively uniform square beam includes a relatively uniform transverse distribution.

30. The system of claim 25, wherein the adjustable aperture quadrupole includes a rectangular-shaped vacuum chamber.

31. The system of claim 25, including wherein each of the quadrupole magnet and the adjustable aperture quadrupole focus one dimension of the plurality of charged particles at a time.

32. The system of claim 25, wherein the quadrupole magnet includes a first order focusing moment and the adjustable aperture quadrupole includes a second higher order folding moment.

33. The system of claim 25, wherein the adjustable aperture quadrupole is positioned downstream of the charged particle beam generator and the quadrupole magnet and generally offset therefrom by approximately 45 degrees.

34. The system of claim 25, wherein the relatively uniform square beam includes a y-axis distribution of approximately 0.2 meters and an x-axis distribution of approximately 0.2 meters.

35. The system of claim 25, wherein the quadrupole magnet includes a maximum field gradient of 0.79 T/m.

36. A process for producing a relatively uniform transverse irradiation field of a charged-particle beam, comprising the steps of:
emitting a charged particle beam with a beam generator;
sizing the charged particle beam with a quadrupole magnet for passage through an adjustable aperture quadrupole; and transforming the charged particle beam with the adjustable aperture quadrupole into a transverse charged particle beam having a relatively square distribution and a relatively uniform density.

37. The process of claim 36, including the step of adding an octupole moment with the adjustable aperture quadrupole.

38. The process of claim 37, wherein the octupole moment comprises a positive octupole moment or a negative octupole moment.

39. The process of claim 36, including the step of desensitizing a peak intensity of the charged particle beam with a second adjustable aperture quadrupole.

40. The process of claim 36, wherein the quadrupole magnet includes a first order focusing moment and the adjustable aperture quadrupole imparts a high order folding moment to attain the transverse charged particle beam.

41. The process of claim 36, including the step of shaping magnetic scalar potential equipotential with a pair of pole faces integrated into the adjustable aperture quadrupole.

42. The process of claim 41, including the step of exciting a higher order field with the pair of pole faces.

43. The process of claim 42, including the step of changing the higher order field while generally maintaining a quadrupole strength.

44. The process of claim 43, including performing the changing step in real-time.

45. The process of claim 36, including the step of passing the charged particle beam through the adjustable aperture quadrupole with relatively lossless transmission.

46. The process of claim 36, including the step of folding a Gaussian transverse beam distribution with a positive octupole moment.

47. The process of claim 36, including the step of fine tuning a transverse beamline of the charged particle beam.

48. The process of claim 36, including the step of changing an excitation current and scaling the field amplitude.

49. A process for adjusting a field component strength of a quadrupole, comprising the steps of:
disposing a first charge plate having a first charge relative to a second charge plate having a second charge generally positioned opposite thereof; and
adjusting an offset distance between the first charge plate and the second charge plate, thereby simultaneously altering a magnetic field in an adjustable channel having a size and shape for controlled passage of a charged particle beam therethrough.

50. The process of claim 49, including the step of independently controlling a field component strength by shifting at least one of a first pole face associated with the first charge plate or a second pole face associated with the second charge plate, wherein shifting displaces the first and second pole faces relative to one another about a symmetry plane.

51. The process of claim 49, including the step of generating an electrical current through at least one coil in each of the first and second charge plates to generate the respective first and second charges.

52. The process of claim 51, wherein the at least one coil includes an upper coil residing within an upper charge plate and a lower coil residing within a lower charge plate.
